(19) United States
(12) Patent Application Publication
(10) Pub. No.: US 2017/0173500 A1
(43) Pub. Date: Jun. 22, 2017

(54) FILTER WITH FLEXIBLE RIBS

(71) Applicant: Kuss Filtration Inc., Findlay, OH (US)

(72) Inventors: Scott A Salsburey, Ottawa, OH (US); Michael E. Yost, Tiffin, OH (US)

(73) Assignee: Kuss Filtration Inc., Findlay, OH (US)

(21) Appl. No.: 15/385,183

(22) Filed: Dec. 20, 2016

Related U.S. Application Data
(60) Provisional application No. 62/270,314, filed on Dec. 21, 2015.

(51) Int. Cl. B01D 29/07; B01D 46/10; B01D 29/13; B01D 46/00; B01D 29/11; B01D 29/01

(52) U.S. Cl. CPC B01D 29/07; B01D 29/111; B01D 29/016; B01D 29/13; B01D 46/0001; B01D 46/10; B01D 2201/04; B01D 2275/10; B01D 2275/201

(57) ABSTRACT

The present disclosure provides a filter and a method of forming the filter which includes two layers of filtering media and outer plastic ribs that form a flat structure. When the ribs are moved towards each other, the two layers of filtration media are separated apart to form a cylindrical filtration structure for mounting to a connecting unit.

### CROSS REFERENCE TO RELATED APPLICATIONS

This application claims the benefit of U.S. Provisional Patent Application No. 62/270,314 filed Dec. 21, 2015, the content of which is hereby incorporated by reference in its entirety.

### FIELD

The present disclosure relates to a method for making a cylindrical or basket shaped filter, such as for filtering liquid or gaseous materials.

### BACKGROUND

Liquid strainer assemblies include a filter body formed from filtering media shaped to define an enclosed interior space. The liquid strainer assembly is attached to an inlet of a fluid suction system, and filters particulate matter from the liquid as a pump or suction device draws the fuel therein. Some filter bodies are shaped by rolling a flat screen, mesh or other filter media into a cylindrical shape, and molding a support structure there-around. Other filter bodies include two flat filter media layers that are attached to each other around their peripheries to form an interior space therebetween. In order to keep the first wall and the second wall from collapsing against each other as the pump suctions liquid therethrough, a separator may be over-molded onto one or both of the first wall and/or the second wall, and disposed between the first wall and the second wall. The over-molded separator may include a plurality of rails, ribs, pads, standoffs, etc., that space the first wall from the second wall.

### SUMMARY

The invention may include any of the following aspects in various combinations and may also include any other aspect described below in the written description or in the attached drawings.

The present disclosure relates generally to a filtering apparatus and a method for making the filtering apparatus, especially for filtering liquid and gaseous materials, in which the filter comprises a filtration media and molded plastic ribs arranged along the edges or near edges of the filtering media. The plastic ribs form a support skeleton that is injection-molded onto the filtering media and may additionally be injection-molded through the porous opening of the filtering media. The filter may be installed to a connecting unit or supply line with a mounting ring, connector or mounting element. More specifically, the present disclosure relates to a construction for a filtering apparatus which includes two layers of filtering media and outer plastic ribs that form a flat structure, and when the ribs are moved towards each other the two layers of mesh cloth are separated apart to form a cylindrical filtration structure for mounting to a connecting unit.

One advantage of the flat structure with two mesh cloth layers provides the ability to process and manufacture in a flat form inside an injection mold without the need to shape the mesh cloth into a cylindrical shape prior to or during the molding process.

The filtering apparatus that can be easily manufactured in a flat form inside an injection mold with two layers of filtering cloth inserted inside the injection mold and plastic injected onto and through the filtering cloth. The finished filtering apparatus has the ability to be opened and formed into a generally cylindrical filter shape for attachment to the connecting unit.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 shows a perspective view of a prior art cylindrically molded basket with a filtering layer

FIG. 2 shows a front view of a filter in a flat form in accordance with the teachings of the present disclosure.

FIG. 3 shows a front perspective view of the filter of FIG. 2 in a cylindrical form.

FIG. 4 shows the filter of FIG. 2 assembled and prior to releasing the band for installation on to a mating component.

FIG. 5 shows a front perspective view of the filter of FIG. 2 as installed on to a fitting with the mating band or strap cut away for viewing.

FIG. 6 and FIG. 7 show a side perspective view of the filter of FIG. 2 as installed on to a fitting.

### DETAILED DESCRIPTION

All figures serve illustrative purposes only and are not intended to limit the scope of the present invention. The drawings are generally to scale, but some features may not be true to scale and serve to emphasize certain details of the various aspects of the invention. Common items between different embodiments in the figures have common reference numerals.

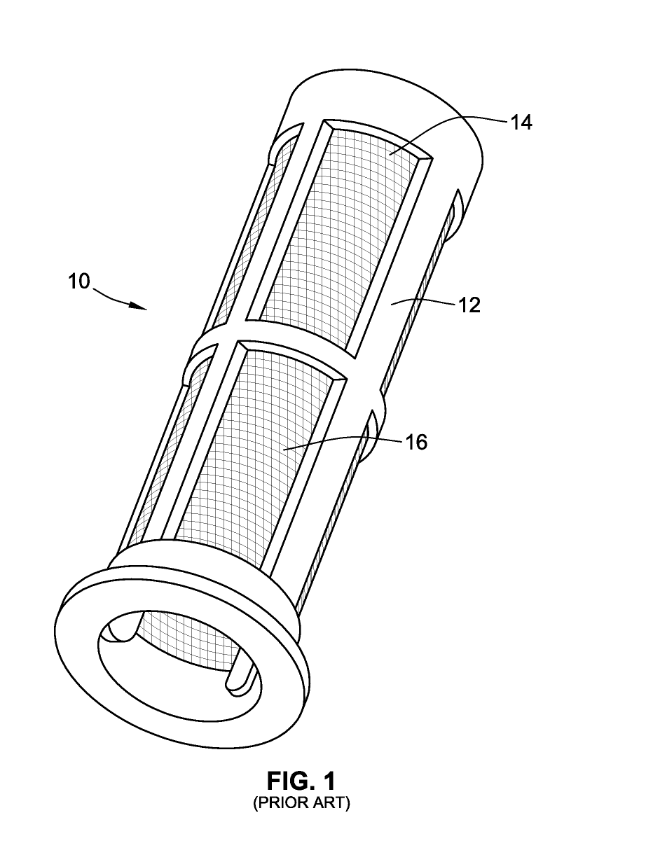

FIG. 1 illustrates the current state of the art for a cylindrical screen filter 10 using a solid cylindrical frame 12 defining a plurality of windows 14, with filtering cloth 16 in each window. This form is molded using filter cloth 16 that is formed into a cylindrical shape prior to insertion into an injection mold, and then plastic is injected around the filter cloth 16 to create the frame 12 having a solid formation of plastic around the filter cloth 16 forming a dimensional cylindrical filter 10.

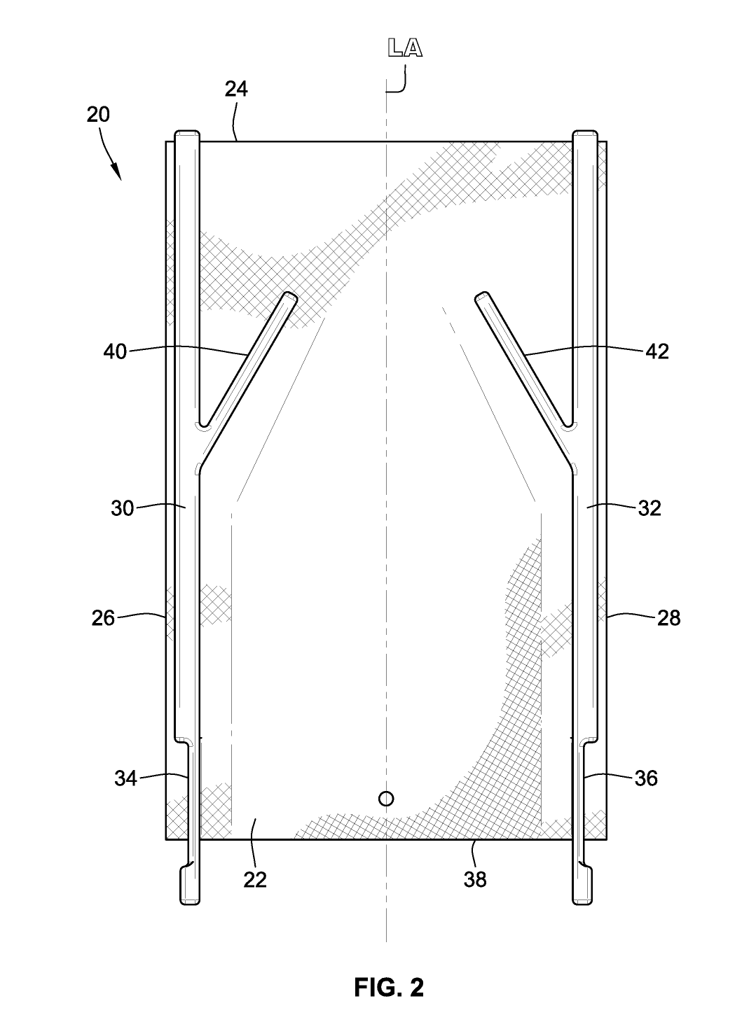

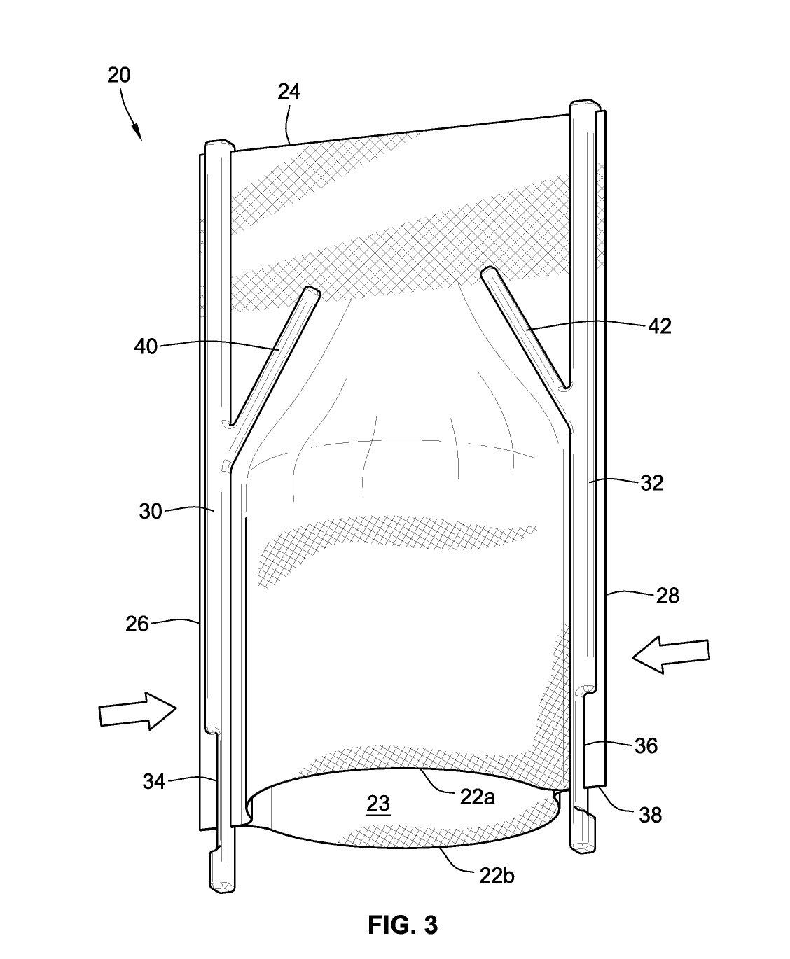

FIG. 2 illustrates a front view of one embodiment of the filter 20 of the present disclosure. The filter 20 has a flat form when first manufactured in the injection mold. A flat filtering media 22, such as a sheet of screen or cloth, is laid in two layers 22a, 22b (see FIG. 3) into an injection mold (not shown). Preferably the filtering media 22 is a single piece of material that is folded over once, whereby the edge 24 formed by the fold (the edge at the top of the page in FIG. 2) does not need to be sealed, and thus only the two opposing side edges 26, 28 are sealed together. Thereafter, plastic is injected around, and in some cases through, the filtering cloth 22 to create plastic ribs 30, 32 along the peripheral edges 26, 28 of the filter media 22 to form a support structure or skeleton for the filter 20. The two plastic ribs 30, 32 are preferably spaced slightly inwardly from the opposing edges 26, 28 (i.e. towards the longitudinal axis LA or flow axis) to leave a portion of the filtering media 22 exposed along the opposing edges 26, 28.

While injection molding of plastic can be used to seal the side edges 26, 28, other materials (e.g. elastomers, adhesives, metals and alloys) and other techniques (e.g. manual application, spraying, crimping, welding, etc.) may be used to seal the two layers 22a, 22b together along the edges 26, 28 of the filter 20. When two separate sheets are used for the filter media 22, the top edge 24 is also sealed using any of the foregoing materials and methods. A bottom edge 38 of the filtration media 22 is not sealed, thereby forming an opening 23 (FIG. 3) to the interior space between the layers 22a, 22b, as will be described further hereinbelow.

The filtration media 22 described herein can be utilized in the filtration of a number of fluids including, but not limited to, fuel such as unleaded fuel or diesel fuel, hydraulic fluid, power steering fluid, lubrication oil, urea, propane, natural gas, air, diesel emissions fluids and other fluids (both liquid and gaseous). Accordingly, the filtration media 22 may be any media suitable for the particular use, such mesh, cloth, paper and the like. Preferably the filtration media 22 is a woven screen or mesh, and extruded screen or mesh, or an expanded aperture film formed of any suitable fuel tolerant and impervious material, e.g. nylon, polyester, acetal or Teflon™. The filtration media 22 can also be constructed from any non-woven or woven material exhibiting sufficient durability. Further, the filter media 22 may be a gradient depth filter media comprising a plurality of non-woven layers, such as melt blown filaments or spun bonded filaments (e.g. of nylon), but may also comprise a single media layer or multiple media layers that are not gradient in structure. One such depth media is disclosed in U.S. Pub. No. 2014/0202951, the entire disclosure of which is incorporated herein by reference.

After molding, the filter 20 is manipulated into a cylindrical configuration for attachment to a fitting or other matting component such as a pipe, as shown in FIG. 3. To facilitate this, the support ribs 30, 32 preferably include several features. Notably, the ribs 30, 32 preferably have sufficient flexibility to bend without failure, and thus may be made from nylon, acetal, polyester, polyethylene, polypropylene, thermoset plastics or elastomers, or blends thereof. Similarly, the ribs 30, 32 preferably have a thickness (i.e. in-and-out of the page in FIG. 2) of about 1.0-3.0 mm. Each rib also preferably includes a reduced width section 34, 36 adjacent the bottom end 38 to facilitate attachment. The reduced width sections 34, 36 extend over a portion of the filtration media 22 near the bottom end 38, and may also extend beyond the bottom end 38 of the media 22 as shown in the figures. The ribs 30, 32 are generally co-planar and parallel to each other, although they may also be rotated relative to each other and the longitudinal axis LA (e.g. angled towards each other as they approach the top end 24).

FIG. 3 shows an isometric view of the filter 20 to illustrate the ability of the bottom end 38 to open up into a cylindrical shape with space between the two layers 22a, 22b of the filtration media 22. As indicated by the large arrows, the two ribs 30, 32 are brought closer together, e.g. through manual manipulation, to space the layers 22a, 22b apart at their bottom ends 38 and form a cylindrical opening 23.

As best seen in FIGS. 2 to 4, the ribs 30, 32 may also include arms 40, 42 extending inwardly towards the longitudinal axis LA. Preferably the arms 40, 42 are angled about 30 to 60 degrees relative to the axis LA of the ribs. The arms 40, 42 project away from the open bottom end 38 and extend towards the closed top end 24. The arms 40, 42 are preferably located closer to the top end 24 than the bottom end 38. The arms 40, 42 help shape the bending of the filtration media 22 when it is manipulated into the cylindrical configuration.

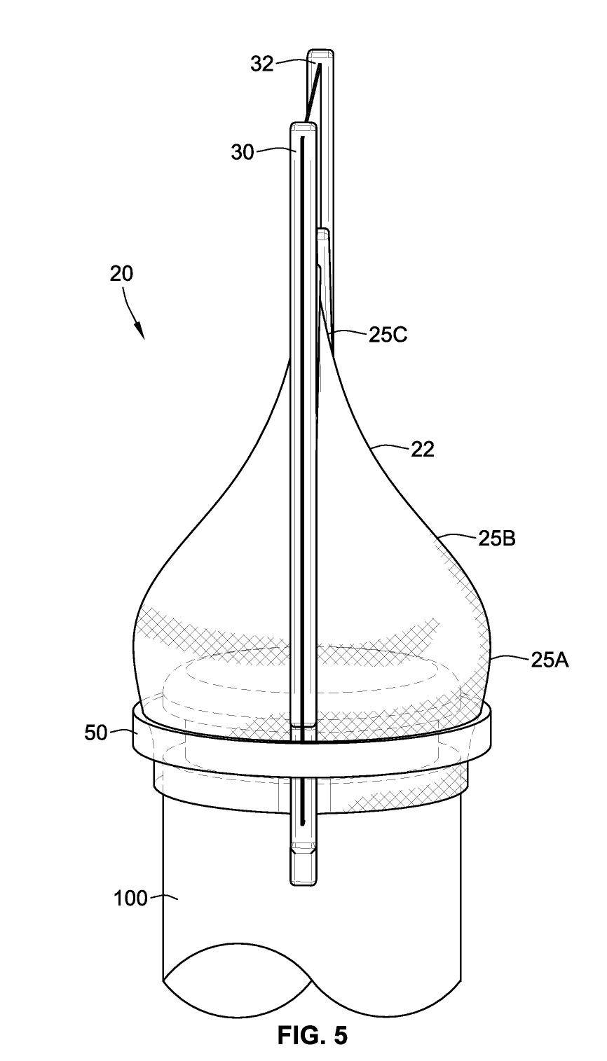

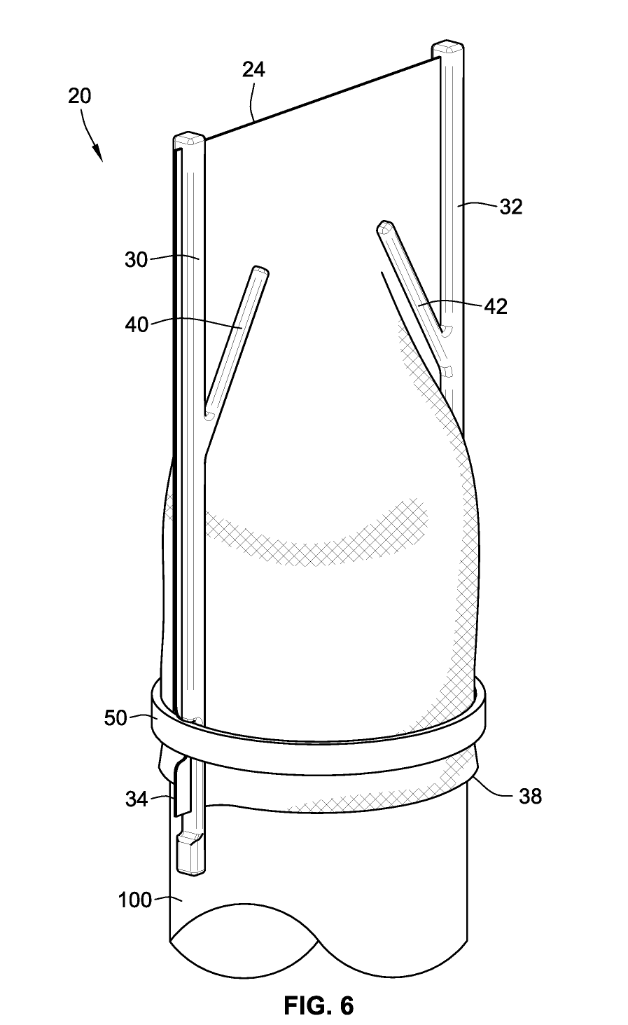

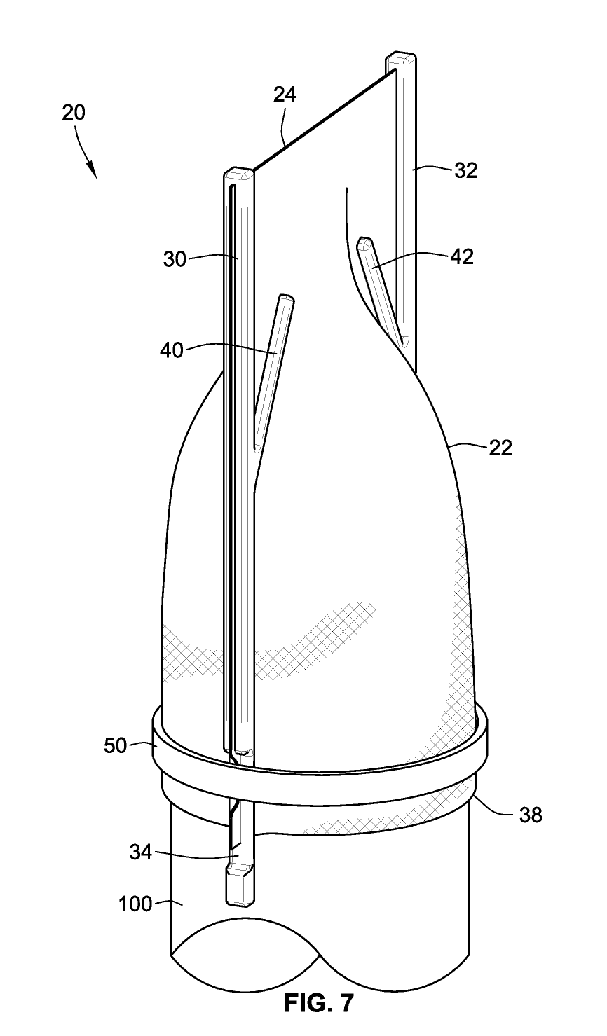

In particular, and as best seen in the side view of FIG. 5, the arms 40, 42 help form a tapered intermediate section 25b, e.g. conical or frusto-conical, as the filtration media 22 transitions from a cylindrical bottom section 25a into a flat top section 25c. The arms 40, 42 provide further structural integrity to the top portion of the filter 20 adjacent the top end 24. As best seen in the perspective views of FIGS. 6 and 7, the arms 40, 42 help shape the bending of the filtration media 22 and provide further structural integrity to keep the media layers 22a, 22b spaced apart.

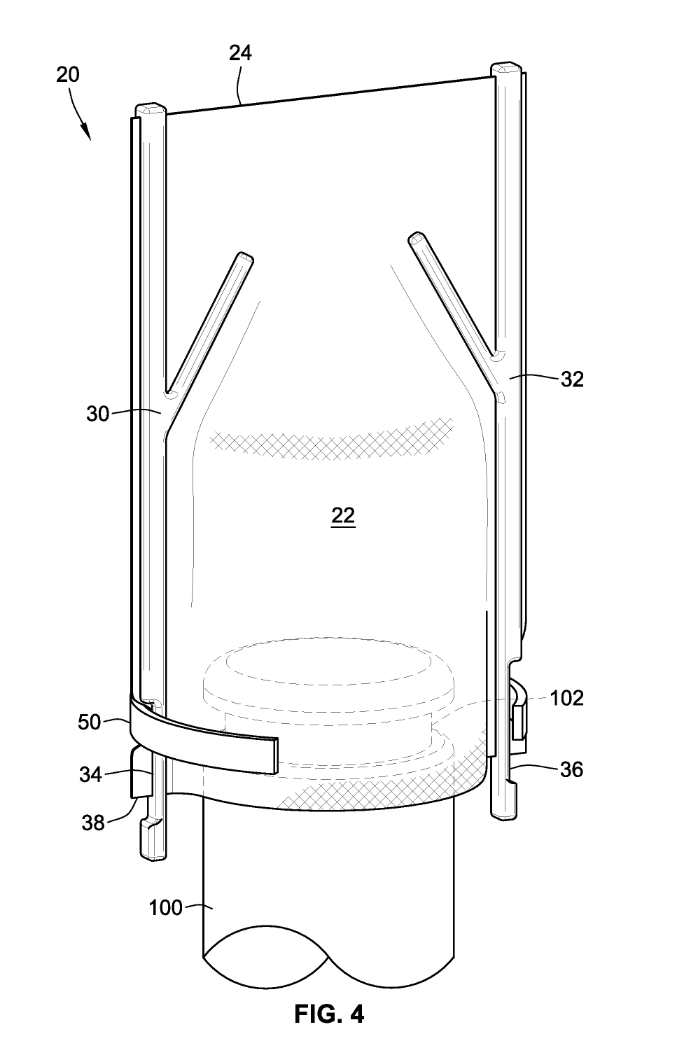

Turning back to FIG. 4, the formerly flat filter 20 has been flexed into a cylindrical configuration and attached around the fitting 100, e.g. a connecting unit, pipe hose, tube, mandrel, nozzle, or the like, for flowing fluid or gases. In this illustration, an attachment band 50 of flexible gage material is placed around the filter 20 and form a seal around the fitting 100 when installed, as shown in FIGS. 6 and 7. The attachment band 50 is of a type to open up and then tighten around and wrap around the fitting 100 to seal and attach the filter 20. The band 50 may be an open metal ring that is crimped or otherwise manually tightened, a ring that is biased to the closed position such that it is spread apart and placed around the filter 20, or may be a closed ring such as an elastomeric band.

As best seen in FIG. 4, the fitting 100 preferably includes a reduced diameter attachment channel 102, e.g., adjacent its free end that is sized to receive the band 50. Likewise, the ribs 30, 32 of the filter 20 include the reduced width sections 34, 36 that flex into the attachment channel 102 and are sized to receive the band 50. The reduction in width at sections 34, 36 is preferably sized to be about equal to or greater than a width of a connecting band 50.

As shown in FIGS. 6 and 7, upon application of the band 50 the filter 20 is securely attached and sealed to the fitting 100. Likewise, the position of the ribs 30, 32 relative to one another and the longitudinal axis LA (i.e. moved closer together to form opening 23 in the filtration media 22), is maintained via attachment of the band 50. The structure of the ribs 30, 32 and their arms 40, 42 facilitates this attached configuration of the filter 20 where the cylindrical bottom section 25a is sealingly connected to the fitting 100 and transitions into a tapered intermediate section 25b leading into a flat top section 25c. Depending on the material of the filtration media 22, the arms 40, 42 may extend completely up to the top end 24 to space the layers 22a, 22b apart completely such that the top section 25c is not flat.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method of forming a filter having filtration media for filtering fluid, the filter having a longitudinal axis, the method comprising the steps of:
overlapping first and second layers of filtration media to define a top edge, a bottom edge, and two opposing side edges extending between the top edge and the bottom edge, the first and second layers being sealed along the top edge;
injecting thermoplastic resin material along the two opposing side edges to create first and second ribs, the first and second ribs spaced-apart and adhered to the filtering media to seal the opposing side edges, the bottom edge forming an opening for connection of the filter.

2. The method of claim 1, wherein the step of overlapping includes folding filtration media over on itself to define a folded edge, the folded edge being the top edge.

3. The method of claim 1, further comprising the step of moving the first and second ribs towards each other to space the first and second layers apart to expose the opening.

4. The method of claim 3, wherein the moving step causes the filter to have cylindrical bottom section and a tapered intermediate section.

5. The method of claim 3, further comprising the step of placing a band around the filter adjacent the bottom edge to maintain the exposure of the opening.

6. The method of claim 5, wherein the first and second ribs are formed to extend longitudinally beyond the bottom edge, and wherein the band extends around the ribs at a longitudinal location above the bottom edge.

7. The method of claim 5, wherein the first and second ribs each include a reduced width section sized to be equal or greater than a width of a connecting band.

8. The method of claim 1, wherein the first and second ribs are formed to each include arms projecting inwardly towards the other rib.

9. The method of claim 1, wherein the first and second ribs are spaced inwardly from the opposing edges and towards the flow axis to leave a portion of the filtering media exposed along the opposing edges.

10. The method of claim 1, wherein the first and second ribs are formed to be 1.0-3.0 mm thick.

11. A filter for connecting to a fitting, the filter having a longitudinal axis, the filter comprising:
first and second overlapping layers defining a top edge, a bottom edge, and two opposing sides edges extending between the top edge and the bottom edge, the first and second overlapping layers being sealed along the top edge;
first and second ribs of thermoplastic material connecting the first and second layers of filtration media along the two opposing longitudinal edges, the first and second ribs and the first and second layers of filtration media defining an opening between the first and second layers along the bottom edge; and
a band extending around the filtration media and the first and second ribs at a location adjacent the opening for connecting the filter to the fitting.

12. The filter of claim 11, wherein a sheet of filtration media is folded over on itself to define the top edge of the first and second overlapping layers.

13. The filter of claim 11, wherein portions of the first and second ribs located adjacent the bottom edge are brought towards each other by the band to give the opening a cylindrical shape.

14. The filter of claim 11, wherein the band is formed of an elastomeric or metal material and is biased towards a closed position sized to seal the filter to the fitting.

15. The filter of claim 11, wherein the ribs extend longitudinally beyond the top edge and the bottom edge.

16. The filter of claim 11, wherein the filtering media is one of a woven screen, an extruded screen, an expanded aperture film, and a multiple layer depth media.

17. The filter of claim 11, wherein the first and second ribs include arms projecting inwardly towards the longitudinal axis.

18. The filter of claim 17, wherein the arms are angled between 30 to 60 degrees of the first and second ribs.

19. The filter of claim 11, wherein the first and second ribs each include a reduced width section sized to be about equal to or greater than a thickness of the band.

20. The filter of claim 11, wherein the filter has a cylindrical bottom section and a tapered intermediate section.
